(19) United States
(12) Patent Application Publication
(10) Pub. No.: US 2012/0075695 A1
(43) Pub. Date: Mar. 29, 2012

(54) HOLDER FOR CARRYING AND FACILITATING AUTO-LOADING OF MICROSCOPE SPECIMEN SLIDES

(76) Inventors: Christopher A. DeBlasis, West Caldwell, NJ (US); Michael C. Montalto, Brielle, NJ (US); Matthew S. Zelinski, Port Barrington, IL (US); Joseph Masino, III, Howell, NJ (US)

(21) Appl. No.: 12/889,087

(22) Filed: Sep. 23, 2010

(51) Int. Cl. G02B 21/26

(52) U.S. Cl. 359/391

(57) ABSTRACT

Pathology specimen slides are positively located on trays, and picked and placed by an auto-loader. The trays are received in a rack in tiers accessed by an auto-loader that moves the slides between the trays and a digital imaging microscope. The trays can have rows of receptacles for slides with standoff structures spacing the slides above a tray bottom. Lateral and endwise partitions defining the receptacles are inclined oppositely inwardly for guiding a slide into the predetermined position on the tray. The autoloader has a manipulator that grasps the ends of slides presented in a front row, and can reach over the front row to grasp slides in one or more rows beyond the front. The manipulator lifts the slide between the inclined surfaces of the partitions, loads and later retrieves the slide from the microscope and replaces the slide in the holder.

### BACKGROUND

This disclosure relates to apparatus for managing sets of glass specimen slides in a digital pathology system. The slides are kept in a slide holder tray from which an autoloader picks the slides, places the slides in an automated microscope for recording digital images, and replaces the slides after imaging.

The specimen slides are prepared by a histology technician who mounts the specimens, preferably identifies the slides with markings, and manually places the slides in the tray. The slides in a tray may be associated with one another as members of a given patient case, or they might comprise slides of multiple cases.

Digital pathology systems capture microscopic images of specimen slides as digital image files. The files are made available over data communication networks for review by pathologists, and are part of a computerized medical information system comprising images, patient information and also other information.

Some steps undertaken in connection with computerized pathology are the same steps practiced in traditional pathology. For example, preliminary histological operations are needed whether the specimens are viewed in a manually operated optical microscope or are digitally imaged. Histological steps may include blocking and sectioning of tissue specimens, mounting sections on glass slides, staining the sections with contrast enhancing stains, drying, covering and labeling the slides, and placing the slides in some sort of receptacle in which the slides are managed as a group, e.g., transported, taken for viewing and stored.

In manual operations, a receptacle for a set of slides should be adapted for manual access, with finger clearance for placing and manually retrieving the slides. The receptacle might be a box or rack with spaced slots or depressions for slides placed on edge in the slots with sufficient spacing for grasping outer edges of the slides, laterally or longitudinally, between the thumb and index finger.

A known flat receptacle is a so-called slide “folder,” which is a laminate of thick paperboard with cutouts complementary to the slides and slightly longer than the slides. The openings for the slides are die cut, providing side walls perpendicular to the plane of the sheet, closed on the back by a backer sheet. The cutouts provide spaces to receive 20 slides in two rows of ten, wherein the slides are separated from one another by about 0.25 inch (63 mm) along their longitudinal edges.

For manual holders, slide placement should be such that there is little or no tendency to leave a fingerprint in the area of the specimen. Therefore, opposite edges of the slide may be grasped. Or for slides with labels, the slide can be grasped at its upper and lower faces at the where the slide is labeled.

A slide receptacle for digital pathology needs to have some aspects similar to those of manual slide holders. At least the histologist uses the receptacle “by hand,” namely manipulating the slides manually in order to place prepared slides in the receptacle, perhaps picking slides out manually after temporary storage before certain preparation steps, to carry the receptacle about with slides therein, etc. But in connection with a robotic slide scanning microscope, an optimal receptacle for digital pathology has different needs as well. For example, cardboard folders in which slides fit snugly in their recesses are not apt for access using a mechanical manipulator for picking up and also replacing slides. It is important for a mechanical manipulator to find the slide needing to be picked up, precisely at the location where the manipulator is configured to attempt to grasp the slide. The path of the manipulator and the slide that it carries is precisely defined by the manipulator's controller and must be accommodated.

It would be advantageous to provide a slide receptacle that is convenient for a histology technician's use as an organizing rack in which slides are readily placed and stored manually. The slide receptacle should be relatively secure and protective as a long term slide receptacle and as a carrier for transport. The receptacle needs to be configured to enable a robotic manipulator accurately to pick and place the slides. And in addition these aspects, the receptacle should be both durable and inexpensive.

### SUMMARY

It is an object of this disclosure to produce a slide tray that is an efficient receiver and carrier for managing slides and also functions like a removable magazine that can be feed slides to and from an autoloader and receive them back again, at a positively defined placement location.

For such purposes, microscope slides carrying tissue specimens for review by a pathologist are kept in holders stacked in a positioning unit accessed by an auto-loader for moving the slides from the holder to and from a digital imaging microscope. The holder forms a tray with receptacle areas for the slides, preferably in two rows. The tray has a bottom panel with standoff ridges to hold the slides off the bottom, and lateral and longitudinal (endwise) partitions that are chamfered to define oppositely inwardly inclined surfaces leading up to a predetermined position at which the slides are nominally located for picking and placement. The chamfer surfaces can diverge laterally proceeding upwardly away from the bottom panel and converge proceeding downwardly, guiding a slide down to the predetermined position. Alternatively or in addition, partitions can diverge and converge proceeding in a longitudinal direction from a presented at which an autoloader accessed the slide. The autoloader can have a manipulator, for example, that grasps over and under presented ends of slides in a front row, and can reach over the front row to grasp presented ends of slides in one or more rows beyond the front. The manipulator engages and displaces the slide between the inclined surfaces of the partitions, loads and retrieves the slide from the microscope and replaces the slide in the holder.

Among other objects of this disclosure, a slide holder is configured in the form of a tray that organizes a plurality of slides in a group. The slide holder comprises structures receiving individual slides of nominal dimensions and locates multiple slides at accurate positions in an array, whether the slides are placed manually or robotically. The array is compact and can have multiple tiers or rows of slides. The slide holder can be configured with standoff structures, i.e., spacers to minimize contact with the wide areas (faces) on opposite sides of the slides, such as a rounded bump or pattern of bumps, one or more posts or pins, a lateral ridge with a knife edge or flat edge, holding the lower face of the slide at a clearance above the tray to enable engagement with a grasping manipulator over and under the slide when picking up and for unimpeded disengagement when replacing a slide. Alternatively or additionally, the slide can be grasped at a cutout in the bottom of the tray or with a different sort of manipulator such as a suction head. The holder functions as a traditional slide holder, as a filing device for patient tissue samples, and as a positive positioning magazine element for passing precisely located slides to and from an autoloader.

### BRIEF DESCRIPTION OF THE DRAWINGS

These and other objects and aspects will be appreciated by the following discussion of preferred embodiments and examples, with reference to the accompanying drawings, wherein:

FIG. 1 is a perspective view showing a specimen slide holder for glass slides to be inserted and held or removed, transported, manipulated and viewed and/or imaged in a microscope, according to an exemplary embodiment;

FIG. 2 is a partial section view of a slide holder taken through two slide widths and viewing in the longitudinal direction of the slides.

FIG. 3 is an illustration of a rack arranged to receive a plurality of slide holders as in FIG. 1, in vertically registered positions, through slots in a housing.

FIG. 4 is a perspective view of an alternative embodiment of a slide holder, wherein tiers of slides are inclined such the ends of slides on one row overlie opposite ends of slides on a next adjacent row.

FIG. 5 is a perspective view of a portion of the embodiment of FIG. 7, shown loaded with slides.

FIGS. 6-8 show the relationship of the slide tray rack (a top slide holder being shown) to a robotic manipulator that picks and places slides and by which slides are brought back to the slide tray after imaging. FIG. 6 shows an exemplary manipulator arm and drive arrangement, showing degrees of freedom for X-Y-Z and rotational movement. FIG. 7 shows rotation between storage and imaging orientations. FIG. 8 shows an exemplary manipulator head.

### DETAILED DESCRIPTION OF EXEMPLARY EMBODIMENTS

According to this disclosure, a holder or tray 20 for glass specimen slides 22 is configured with aspects that assist in managing the slides associated with one or more patient cases during preparation and finishing stages by a histology technician and also for robotic access in connection with scanning during which the slides are temporarily removed from the holder by a robotic manipulator for imaging and thereafter are replaced in the holder.

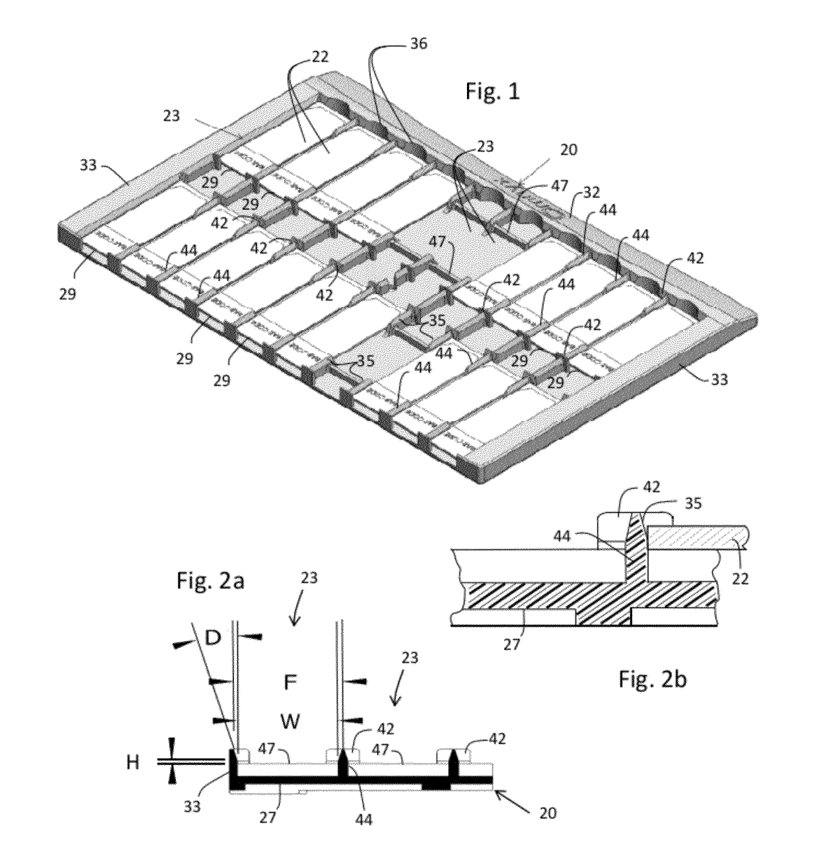

An exemplary holder for microscope slides is shown in FIG. 1. The slides 22 are shaped as flat rectangular glass plates. Although not show in detail, each slide 22 can be considered to carry a tissue specimen that has been prepared (blocked, sectioned, mounted and stained) by a histologist from a sample obtained by a physician. The tissue is placed under a transparent cover slip. At one or both ends beyond the sample carrying zone, the slide is labeled, for example with a barcode or other identifying code that is associated in data records with the slide and the patient's case and the manner of processing.

A standard microscope slide measures about 75 mm by 25 mm (3″ by 1″) and is 1.1 mm thick. Other sizes are possible, but it is normal that slides have a reasonably tight tolerance as to length and width, e.g., ±0.1 mm, so as to fit precisely into microscope stage slide holders or other fixtures in which the slide is expected to reside at a nominal location relative to other parts.

The holder or tray 20, which can comprise, for example, injection molded plastic, defines at least one row of pockets or receptacle areas 23 for receiving slides 22. Each of the receptacle areas 23 is dimensioned to receive a microscope slide 22 carrying a specimen. According to one aspect shown in FIG. 1, the receptacle areas 23 are configured such that at least certain edges of slides 22 when placed in the receptacle areas 23 are registered into predetermined positions. The slides 22 are thus located at predetermined locations relative to the external structures of the holder or tray 20 and at also at predetermined locations relative to one another.

As also shown in FIG. 1, in the receptacle areas 23, the slides 22 are presented with clearance for engagement, either by a human's fingers or by a robotic manipulator. The holder or tray 20 has a bottom panel 27. The slides 22 rest on structures provided on the upper surface of the bottom panel 27 that act as standoffs, and the ends of the slides 22 that all are presented in one direction, namely the edges 29 at the labeled of the slides in FIG. 1, are held at a space above the bottom panel 27.

The holder or tray 20 has a frame around at least part of its outer perimeter. In FIG. 1, the frame comprises a handle part 32 and two opposite side members 33. At the fourth edge of the holder/tray 20 the labeled ends of slides 22 are exposed. The row of slides remote from the handle 32 can be termed the forward row; and the row adjacent to the handle 32 can be termed the rear or handle row. The ends of the slides 22 facing away from the handle 32 in the forward row are located above the bottom 27 and are exposed, except at the ends of partitions 35 between the adjacent slides in a row. In the area between the partitions 35 and at the opposite ends of the slides in the front row, a person can grasp a selected slide between the thumb and the index finger or another finger.

Along the inner side of handle part 32, finger-sized indents 36 are provided to make the ends of slides 22 accessible adjacent to the handle whereas the opposite or label ends of the slides are exposed and presented toward the same side of the holder/tray as the front row of slides. Thus the rear row can also be grasped between a thumb and finger. Inasmuch as the label ends of all the slides 22 in both rows are presented toward the front side of the tray (opposite from the handle 32), at a space above the bottom 27 of the tray 20, selected slides 22 can be grasped by a robotic manipulator having a lower jaw inserted under the slide at the presented label and an upper jaw that engages downwardly on the top face of the slide at the labeled to pinch the slide between the upper and lower jaws.

The partitions 35 comprise wall members 44 and tabs 42, each of which has a chamfer or sloping face, on a body portion extending from the bottom 27 of the holder/tray 20. The wall members 44 are disposed between adjacent slide receptacles 23. The opposite sides of the wall members 44 define the insides of the receptacles 23 against which the lateral edges of glass slides 22 reside. Ends tabs 42 are similarly shaped but are located at the ends of the receptacles 23, forming the surfaces against which the ends of the slides reside. The faces of the handle 32 and frame members 33 facing inwardly toward the slides have the same shape as the slide-facing sides of partitions wall members 44 and tabs 42.

The shapes of the partition wall members 44 and tabs 42 are shown in FIG. 2a and enlarged in FIG. 2b to show part of a glass slide. The partition members 44 are disposed between the receptacle areas 23, thus two partition members 44 reside on laterally opposite sides of the receptacle areas. Similarly, tabs 42 reside on longitudinally opposite ends of the receptacle areas. The partition members 44 on opposite sides and the tabs 42 on opposite ends have inclined chamfer surfaces arranged such that the lateral and longitudinal dimension of each receptacle area 23 decreases leading downwardly into the receptacle areas, namely in a direction normal to the bottom panel

Therefore, as shown in FIG. 2a, an acute angle “D,” for example of 20 to 30 degrees, is defined by chamfers on opposite sides of partitions 44 between receptacle areas 23. The same or a similar chamfer angle is defined along the inward facing chamfer of frame 33. The entry into the receptacle has a lateral dimension “F.” Due to the chamfer angle “D,” the lateral dimension decreases to a width “W” at the bottom of the chamfer. The width W can be the maximum lateral width of a slide within dimensional tolerances. When the slide is arranged parallel to the bottom 27 and lowered into the receptacle 23, there is a clearance up to width F that diminishes as the slide is lowered into the receptacle 23 to width W. A practical result is that a slide that perhaps is not perfectly positioned is guided by the chamfer surfaces into position at width W when placed in the receptacle 23. Likewise, the slide is guided longitudinally by similar inwardly inclined chamfer surfaces on the tabs 42. These aspects bring the slides into a nominal position longitudinal and lateral X-Y directions relative to the bottom 27.

In a Z direction normal to the bottom 27 of the tray, each slide rests atop at least one standoff that holds the underside of the slide at a space from the top surface of the bottom, freeing a gap between the bottom 27 and the slide for receiving a lower jaw of a gripper of a robotic manipulator, discussed below. In the embodiment shown, there are two standoff structures defined by lateral ridges 47, shown in FIGS. 1, 2a and 2b.

Referring to FIGS. 2a and 2b, the chamfer surfaces on the partitions 44 and tabs 42 can at a distance “H” above the ridge 47. In this case, the portion of the receptacle adjacent to ridge 47 has perpendicular walls over a short height H. This height can range from a small fraction of the thickness of the slide, in which case the slide simply rests on the ridge, to a height at least equal to the thickness of a slide. In such a situation, a slide with a width substantially complementary to dimension W fits more snugly (with a greater distance H) or less snugly. With appropriate coordination of the nominal dimensions of the slides versus the height H, the width W and also the corresponding length between tabs, and the tolerances in slide dimensions, the slides can be relatively loosely or relatively snugly received. In the embodiments shown in FIGS. 2a and 2b, there is a distinct height H, and the slide in FIG. 2b is snugly seated in the receptacle 23, but the height H is small relative to the thickness of the slide and there is only minimal restriction on free movement of the slide into and out of the receptacle.

In any event, distance F at the entrance to the receptacle 23 is greater than distance W where the slide resides. The minimum spacing between the partition members at the base of the chamfer occurs at and optionally adjacent to the ridge extending laterally across the receptacle areas. The chamfer surfaces are provided on at least two opposite sides of the receptacles 23. The dimension between the chamfer surfaces is substantially equal to a maximum dimension of the slides in a corresponding direction (length or width), whereby a slide of said maximum dimension fits between the chamfer surfaces on the two opposite sides. However the clearance reduces from the entering width F to final width W leading toward the bottom 27 of the tray 20. This aspect can be provided in either of length (between tabs 42) or width (between partitions 44). In the embodiment shown, the chamfers guide the slide in both length and width positioning.

Referring to FIG. 1, the partitions 44 are discontinuous along the lateral extension of the slides. At least two spaced partition parts are provided, each extending inwardly from an of the slide and a tab 42. The gap between the spaced partition parts exposes the lateral edges of the slides and optionally can be provided with a sufficient gap along and between adjacent slides to enable the slides to be engaged along the edges with fingers or forceps (not shown in FIG. 1).

In the depicted embodiment, the frame edge around the tray is arranged so that the slides adjacent to frames 33 have continuous chamfered partition surfaces (which in this case are perimeters), but the chamfers on the frames 33 function as described above, namely to cooperate with at least one of the partition members spaced inwardly from the frame edge and defining with the frame edge the opposite sides of one of the receptacle areas.

The tabs are also limited to an area near the corners of the slides. On the presented or front ends 29, this arrangement permits a manipulator that is narrower then the space between adjacent tabs 42 to fit between the tabs 42 when engaging the slide. The manipulator can also fit between tabs positioned in the same way on the presented or front side of a rear row of slides as shown in FIG. 1. The tabs 42 on the handle frame 42 are spaced by the openings 36 that provide finger access.

As mentioned, each of the receptacles 23 has at least one standoff structure protruding upwardly from bottom of the tray in each of the receptacle areas. The standoff structure supports the slide and maintains a clearance between the bottom of the tray and an underside of the slide in its respective receptacle area. The standoff structure can comprise, for example, one or more of a rounded bump, a pattern of bumps, one or more posts or pins, a ridge and a knife edge.

FIGS. 2a, 2b show one ridge as an exemplary standoff structure. Two spaced ridges are provided as standoff structures in the embodiment shown in FIG. 1. In FIG. 1, the plurality of spaced standoff structures protruding upwardly from bottom of the tray in each of the receptacle areas be an equal amount, maintaining a clearance between the bottom of the tray and an underside of a slide in a respective said receptacle area by holding the slides parallel to the plane of the bottom. It is also possible, particularly with one standoff structure adjacent to the front of the slides, to permit the rear of the slides to rest on the bottom 27, i.e., at an incline relative to the bottom.

The tray 20 can define plural rows of said receptacle areas, two rows being shown in FIG. 1. In this case, one row presents ends of slides for a manipulator to engages adjacent to the front edge of the tray and one or more next rows present ends of slides in the same direction but at a distance from the edge of the tray. Therefore, it is necessary for the manipulator to reach over the front row to engage slides in the receptacles of the rear row. It is also possible to embody a tray as shown for access by manipulators from opposite sides.

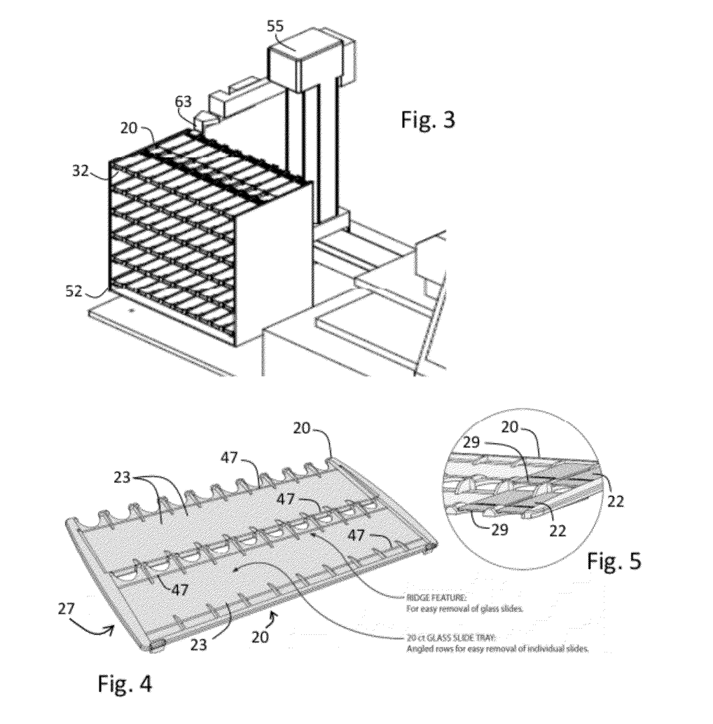

Referring to FIG. 3, the tray or holder 20 can be used for carrying and managing associated slides, especially the slides of one patient case, in a system wherein trays or holders 20 for several patients can be loaded into a rack 52 as shown, for access by a robotic manipulator 55. The slides are positively located at predetermined positions by the receptacle structures of the tray/holder 20 (shown is rotated in FIG. 3 compared to its position in FIG. 1, so that the presentation or front side is oriented toward the rack 52). When tray/holder 20 is pushed fully into the rack 52 in the direction shown by the arrow, the tray/holder 20 is then positively located by its position in the rack. The rack 52 is fixed in position relative to the manipulator 55, e.g., fixed on the same supporting surface. As a result, the slides are positively located in predetermined positions relative to manipulator 55. Thus the manipulator (shown schematically) can extend its grasping device 63 to known locations where slides can be picked and placed.

The positions of the presented ends of each of the slides are destinations along the route followed by a robotic manipulator arranged to pick up the slides from their positions in the tray 20, and to carry the slides to an imaging device (not shown) where the slides are deposited into an imaging apparatus, for example by setting the slides into position on an automated microscope stage, under a macro image scanner or a barcode label reader, etc., or moving the slide to achieve different imaging steps in succession. After imaging as necessary, the manipulator retrieves the slide and returns it, for example to the same position on its tray 20. As shown in FIG. 3, the rack 52 has several tiers on which tray/holders 20 can be inserted. Each of these is available to the robotic manipulator, which is programmed to access and process the slides on each of the trays, optionally to detect positions that are unoccupied, to signal an operator when trays/holders are completed and generally to handle the job of moving slides as needed.

On the tray/holder 20, at least the presented ends 29 of the slides in the one row and at least the presented ends 29 of the slides in the next row can be located so that the manipulator easily can grasp the slides by their ends. This aspect can be achieved in alternate ways. In FIG. 1, the slides are all held co-planar and parallel to the bottom 27. The presented ends 29 can be disposed at a space above the upper surface of the bottom of the tray. The tray can have a cut-out through the bottom of the tray under the presented edges (not shown). Alternatively and as shown in FIG. 4, the slides can be located so as to overlap, with the presented front ends of slides in the rear row being disposed higher than by standoffs and/or by the contour of the tray, to overlap the rear ends of the slides in the front row. The receptacles 23 can be tilted downwardly toward the rear, with or without overlapping of slides. In another embodiment as shown in FIG. 5, the slides can be tiered, with all the slides parallel to the bottom 27 but the rear row being at a higher elevation from the bottom 27 than the front row. As already mentioned, another alternative is to arrange for manipulators to access the tray 20 from both the front and rear sides.

The tray/holder 20 for the microscope slides advantageously is employed in conjunction with an autoloader that removes the slides one at a time, transports the slides to an imaging system. The imaging system can accomplish macro imaging (to collect a full slide view and to read a bar code on the label), and microscopic imaging at one or more magnifications, capturing and storing the images in digital format, i.e., as pixel data files. For this purpose, the positioning unit 52 receives and positions at least one holder 20, thereby placing the slides at predetermined positions relative to the autoloader, namely the positions of the receptacles 23. The holder 20 comprises a tray defining at least one row of receptacle areas, each of the receptacle areas being dimensioned to receive a microscope slide 22 carrying a specimen, wherein the receptacle areas are configured such that at least certain edges of slides placed in the receptacle areas are registered and the slide is presented in predetermined position relative to the autoloader when the holder is in the positioning unit. The tray 20 has a bottom panel 27 and partition members 44, 42, extending from an upper surface of the bottom panel 27 between adjacent ones of the receptacle areas. The partition members 44, 42 between the receptacle areas are chamfered or inclined oppositely inwardly for guiding a slide into the predetermined position in a placement direction. As the slide is displaced, for example, vertically downwardly into a receptacle or longitudinally backward into a receptacle from the original position of the presented edge, or by a combination of such displacements, the inclined edges of the structures that surround and define the receptacles areas guide the slide into a positively defined predetermined location on the tray/holder 20.

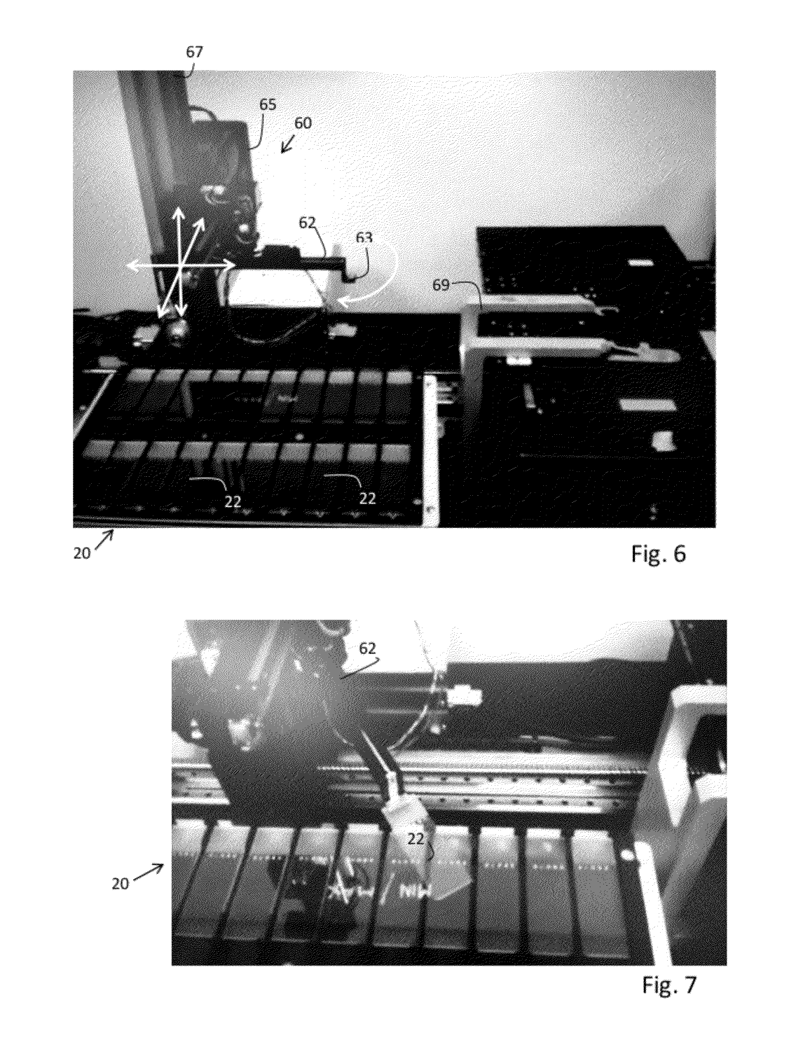

FIG. 6 depicts a practical embodiment of an autoloader for accessing a tray/holder 20, only one being shown for purposes of illustration. In FIG. 6, an autoloader 60 comprises a manipulator arm 62 with a grasping manipulator head 63, controllable to grasp a slide. The arm 62 is carried on a carriage 65 movable vertically on a vertical displacement post 67. The carriage is movable toward and away from the holder 20. The vertical post, while carrying the carriage, is movable toward and away from an imaging apparatus 69. Accordingly, the arm that wields the manipulator head 63 is controllably rotated on a vertical axis relative to the carriage and the carriage is translated in X, Y and Z directions.

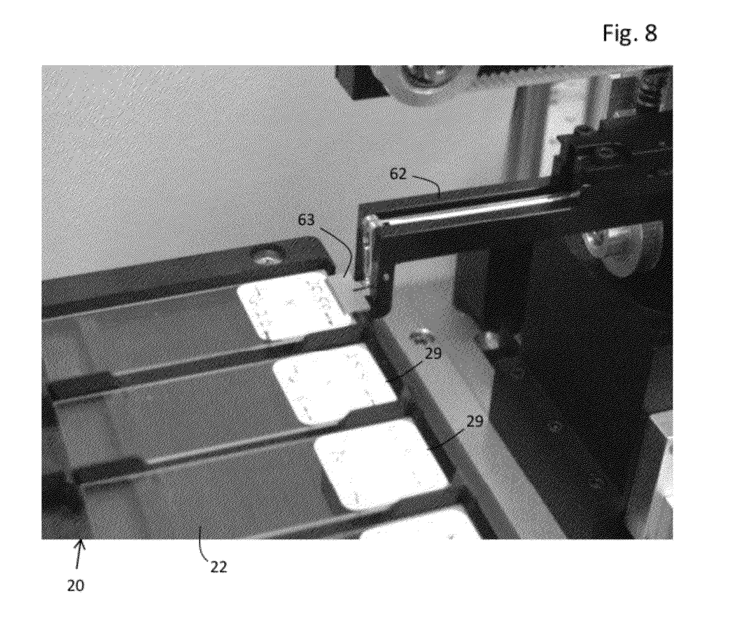

The function of the autoloader is to align the manipulator arm 62 with a slide, moving to a predetermined position on tray 20 where the slide is found. The manipulator head has grasping jaws that are moved over and under the presented front or label of the slide and closed. The slide is lifted and removed from tray 20 and carried to the imaging arrangement, in this example including rotating the slide to align the slide with a destination location on the imaging apparatus. FIG. 7 shows rotation of the arm 62 on the carriage 65 for alignment. FIG. 8 shows the grasping manipulator head 63, which can be solenoid operated or pneumatic. The manipulator can be arranged to provide a signal for indicating when the grasping head 63 closes with or without encountering a slide, e.g., using a limit switch. The various displacements can be driven by motorized belts, rotating threaded shafts or other actuation arrangements.

After imaging a slide, the autoloader can reverse its steps to retrieve and replace the slide at the predetermined position in the tray 20, including lifting and lowering, rotating and/or translating the slide as necessary. In one embodiment, the imaging operation uses multiple slide positions for macro and micro imaging and includes moving the slides from one location to another during the process. In this arrangement, it is possible to place a slide from the holder 20 onto one position on the imaging apparatus and later to retrieve that slide from a different position. Likewise, it is possible to replace a completed slide after imaging in the same position from which it was taken, or for the manipulator to move the slide between points on the imaging apparatus. These selections can be made by a programmed controller that sequences the various operations of the device.

In the embodiments shown, the hotel or rack unit (FIG. 3) positions the slide holder trays 20 such that a plurality of said holders 20 are removably positioned in vertical registry. Each of the holders has at least two rows of receptacle areas at which the slides are rested on standoff structures at a space from an upper surface of the tray to as to present and of the slides for grasping, and the autoloader is configured for displacement of the manipulator in one plane to select a holder, and in two planes orthogonal to said one plane to select a slide for grasping. It should be appreciated that the orientation of these aspects, the number of rows and other similar arrangements can be varied.

The subject inventions and improvements have been disclosed and explained in connection with certain exemplary embodiments but it should be appreciate that the invention is not limited to the embodiments presented as examples. Reference should be made to the appended claims to assess the scope of the invention in which exclusive rights are claimed.

What is claimed is:

1. A holder for microscope slides, the slides comprising flat plates having a nominal length, width and thickness, the holder comprising:
a tray defining at least one row of receptacle areas, each of the receptacle areas being dimensioned to receive a microscope slide carrying a specimen, wherein the receptacle areas are configured such that at least certain edges of slides placed in the receptacle areas are registered in a predetermined position and the slides in the receptacle areas are presented in the predetermined position for engagement and manipulation.

2. The holder for microscope slides of claim 1, wherein the tray has a bottom panel and further comprising partitions extending from an upper surface of the bottom panel between adjacent ones of said receptacle areas.

3. The holder for microscope slides of claim 2, wherein the partitions border the receptacle areas and have inwardly oppositely inclined chamfer surfaces configured such that a dimension leading into one of the receptacle areas decreases approaching the predetermined position, in a direction for placing a slide in said receptacle area.

4. The holder for microscope slides of claim 3, wherein said chamfer surfaces are provided on at least two opposite sides of the receptacles areas and open upwardly away from the bottom panel, wherein a dimension between the chamfer surfaces at the predetermined position is substantially equal to a maximum dimension of the slides in a corresponding direction, whereby a slide of said maximum dimension fits between the chamfer surfaces on the two opposite sides with a reducing clearance leading toward the predetermined position.

5. The holder for microscope slides of claim 3, wherein said chamfer surfaces are provided on opposite sides and opposite ends of the receptacles areas and wherein a dimension between the chamfer surfaces is equal to or minimally greater than a maximum dimension of the slides in a corresponding direction, whereby a slide of said maximum dimension fits between the chamfer surfaces on the opposite sides and on the opposite ends with a reducing clearance leading toward the predetermined position.

6. The holder for microscope slides of claim 3, wherein the partitions are discontinuous along the slides, comprising at least two spaced partition parts and a gap between the spaced partition parts at which the slides can be engaged along edges.

7. The holder for microscope slides of claim 3, further comprising a frame edge around the tray, and wherein the frame edge comprises a chamfer surface cooperating with at least one of the partitions spaced inwardly from the frame edge and defining with the frame edge one of the receptacle areas.

8. The holder for microscope slides of claim 3, further comprising at least one standoff structure protruding upwardly from bottom of the tray in each of the receptacle areas, the standoff structure maintaining a clearance between the bottom of the tray and an underside of a slide in a respective said receptacle area.

9. The holder for microscope slides of claim 8, wherein the standoff structure comprises as least one of a rounded bump, a post, a ridge and a knife edge.

10. The holder for microscope slides of claim 3, comprising a plurality of spaced standoff structures protruding upwardly from bottom of the tray in each of the receptacle areas, the standoff maintaining a clearance between the bottom of the tray and an underside of a slide in a respective said receptacle area.

11. The holder for microscope slides of claim 2, wherein the tray defines at least two rows of said receptacle areas, wherein one row presents ends of slides in said one row adjacent to an edge of the tray and at least one next row presents ends of slides in said next row at a distance from the edge of the tray.

12. The holder for microscope slides of claim 10, wherein ends of the slides in the one row and ends of the slides in the next row are presented with clearance for grasping, the clearance including at last one of a space between an edge of the slides and an upper surface of the bottom of the tray, a gap in the bottom of the tray and a gap between structures that border the predetermined area.

13. The holder for microscope slides of claim 12, wherein the slides in the one row and in the next row are held above the upper surface of the bottom on at least one ridge extending laterally across the receptacle areas of the row.

14. The holder for microscope slides of claim 13, further comprising partition members extending from an upper surface of the bottom panel between adjacent ones of said receptacle areas, wherein the partition members between the receptacle areas have oppositely inclined chamfer surfaces such that a dimension of the receptacle areas decreases leading into the receptacle areas in a direction perpendicular to the bottom panel.

15. The holder for microscope slides of claim 14, wherein a minimum spacing between the partition members at a base of the chamfer surfaces occurs at the ridge extending laterally across the receptacle areas.

16. The holder for microscope slides of claim 11, wherein the one row and the next row are configured such that the slides are inclined downwardly from a presented thereof, and wherein an of the slides presented on the next row overlaps an opposite of the slides on said one row.

17. The holder for microscope slides of claim 3, wherein the slides in the receptacle areas are inclined such that a presented of each slide is higher relative to the bottom of the tray than an opposite.

18. In combination, an autoloader for microscope slides and a holder for the microscope slides, comprising:
a positioning unit configured for positively fixing at least one said holder at a predetermined position relative to the autoloader;
wherein the holder comprises a tray defining at least one row of receptacle areas, each of the receptacle areas being dimensioned to receive a microscope slide carrying a specimen, wherein the receptacle areas are configured such that at least certain edges of slides placed in the receptacle areas are registered and the slide is presented in a predetermined position relative to the autoloader when the holder is in the positioning unit, wherein the tray has a bottom panel and partition members extending from an upper surface of the bottom panel between adjacent ones of said receptacle areas, the partition members between the receptacle areas being chamfered to define oppositely inwardly inclined chamfer surfaces for guiding a slide into the predetermined position;
wherein the autoloader comprises a manipulator controllable to grasp a slide in the predetermined position, move the slide and replace the slide at the predetermined position, including lifting and lowering the slide between the inwardly-inclined chamfer surfaces.

19. The combination of claim 18, wherein the positioning unit is configured to removably carry a plurality of said holders in vertical registry, wherein each of the holders has at least two rows of receptacle areas at which the slides are rested on standoff structures at a space from an upper surface of the tray to as to present and of the slides for grasping, and wherein the autoloader is configured for displacement of the manipulator in one plane to select a holder, and in two planes orthogonal to said one plane to select a slide for grasping.

20. The combination of claim 19, wherein the autoloader is additionally configured for rotation of the manipulator around one of said orthogonal planes.
